(19) United States
(12) Patent Application Publication
(10) Pub. No.: US 2009/0310718 A1
(43) Pub. Date: Dec. 17, 2009

(54) Data distribution system and reception apparatus

(75) Inventors: Toshiyuki Aida, Kariya-city (JP); Yoshitaka Ozaki, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/457,560

(22) Filed: Jun. 16, 2009

(30) Foreign Application Priority Data
Jun. 16, 2008 (JP) 2008-157018

(51) Int. Cl. H04L 27/06

(52) U.S. Cl. 375/340

(57) ABSTRACT

In a data distributing party, original data is divided into sub-blocks. Each sub-block is encoded according to a predetermined encoding/decoding formula, to divide each sub-block into sub-symbols. In the predetermined encoding/decoding formula, data prior to encoding can be restored by obtaining a predetermined number of data from data posterior to encoding. Each symbol is generated by retrieving sub-symbols from respective sub-blocks and each generated symbol is distributed. In contrast, in a data receiving party, when completing the reception of the symbols not less than a predetermined number necessary for restoring, the sub-symbols are extracted from the respective received symbols in an order of receiving the symbols to restore the sub-blocks posterior to encoding. Each restored sub-block posterior to encoding is decoded according to the above encoding/decoding formula to restore each corresponding sub-block prior to encoding. The restored sub-blocks are then joined to one another to restore the original data.

### CROSS REFERENCE TO RELATED APPLICATION

The present application is based on and incorporates herein by reference Japanese Patent Application No. 2008-157018 filed on Jun. 16, 2008.

### FIELD OF THE INVENTION

The present invention relates to a data distribution system, a reception apparatus, a program, and a data distribution method.

### BACKGROUND OF THE INVENTION

Patent document 1: JP-2007-251882 A

Patent document 1 proposes a method for an electronic apparatus to receive data (contents data) from an outside using a data transmission technology, such as a satellite radio broadcast, other than a technology using the Internet.

The data distribution using such broadcast can be applied also to an in-vehicle apparatus, such as an in-vehicle navigation apparatus. In this regard, however, the resources of the primary storage device (also referred to as a main memory) may be typically restricted in such an in-vehicle apparatus. Thus, it is difficult to store a large volume of data such as music data and map data, in the main memory at the same time. While receiving data in several packet units, into which the data is divided, it is necessary to evacuate the received data to an external storage such as a hard disk drive.

Note, however, that a packet loss is apt to occur on condition that a reception state changes like in a vehicle running. This poses a problem of taking time by the time all the packet units can be completely received. That is, without having data retransmission function like the Internet (TCP/IP), the data distribution using broadcast uses the carousel method etc. which transmits repeatedly the same data with fixed intervals. When the packet omission occurs, it is therefore necessary to stand by until the omitted packet is re-transmitted.

As a technology to solve such a problem, a division coding transmission technology is proposed which is a file transfer technology to restore data prior to encoding by obtaining a predetermined quantity of data from data posterior to encoding.

In other words, the technology is a file transfer technology which can restore the data using the predetermined quantity of the packets regardless of the data contents of the packets. In such a technology, using a certain algorithm, the original data are encoded to generate several data items at a distributing party. At a receiving party, the original data can be restored by collecting the data quantity of the original data plus a regardless of any data contents. Therefore, even if a packet loss occurs, it is not necessary to wait for the distribution of the specific packet. Since restoration becomes possible by receiving any packets, there is an advantage that the waiting time, which is required when the packet omission occurs, can be shortened significantly.

However, an in-vehicle apparatus may have the restricted resources of the primary storage device, as mentioned above. When the data evacuated to the external device has a large volume, which cannot be stored in the primary storage device at once, there is a problem that the decoding cannot be executed.

### SUMMARY OF THE INVENTION

It is an object to provide a technology to enable a primarily storage device having a small data storage capacity to receive a large volume of data. Such a technology may be applied to a data distribution system, a reception apparatus, a program, and a data distribution method.

According to a first aspect of the present invention, a data distribution system is provided as follows. A division portion is configured for dividing an original data into several sub-blocks. An encoding portion is configured for encoding each of the sub-blocks, according to a predetermined encoding/decoding formula allowing data prior to encoding to be restored by obtaining a predetermined quantity of data from data posterior to encoding, to thereby generate each of sub-blocks posterior to encoding, each sub-block posterior to encoding containing several sub-symbols. A distribution portion is configured for distributing each symbol which is generated by extracting a single sub-symbol from each of the sub-blocks posterior to encoding. A decoding portion is configured for, on a predetermined condition that a number of received symbols reaches a predetermined number necessary for allowing a restoration of the sub-blocks prior to encoding, decoding each of sub-blocks posterior to encoding, the sub-blocks posterior to encoding which are configured by extracting a single sub-symbol from each of the received symbols, according to the predetermined encoding/decoding formula.

According to such a data distribution system, even if the capacity of the primary storage device of a receiving party is small, a large volume of data can be received. That is, the present data distribution system divides the original data into several sub-blocks; then, the encoding is applied to each sub-block of the several sub-blocks. That is, a single sub-block is a unit for encoding. Even if the original data has a data volume unstorable in the primary storage device, when a single sub-block has a data volume storable in the primary storage device, the decoding process can be executed. Therefore, the data can be distributed regardless of the data size or data volume of the original data. In addition, the data distribution is made in units of symbols instead of in units of sub-symbols. Transmission and reception of the data can be therefore executed efficiently.

As an optional aspect of the data distribution system, the distribution portion may be further configured to generate each symbol such that an order of the sub-blocks, from which the sub-symbols are extracted, is constant.

According to such a data distribution system, the sub-block posterior to encoding can be easily configured by only extracting a single sub-symbol having an identical order from each of the received several symbols.

According to a second aspect of the present invention, a reception apparatus cooperative with a distribution apparatus is provided as follows. First, the distribution apparatus configured for (i) dividing an original data into several sub-blocks, (ii) encoding each of the sub-blocks, according to a predetermined encoding/decoding formula allowing data prior to encoding to be restored by obtaining a predetermined quantity of data from data posterior to encoding, to thereby generate each of sub-blocks posterior to encoding, each sub-block posterior to encoding containing several sub-symbols, and (iii) distributing each symbol which is generated by extracting a single sub-symbol from each of the sub-blocks posterior to encoding. The reception apparatus comprises (i) a reception portion for receiving the symbol and (ii) a decoding portion for, on a predetermined condition that a number of received symbols reaches a predetermined number necessary for allowing a restoration of the sub-blocks prior to encoding, decoding each of sub-blocks posterior to encoding, the sub-blocks posterior to encoding which are configured by extracting a single sub-symbol from each of the received symbols, according to the predetermined encoding/decoding formula.

Such a reception apparatus can provide an advantage comparable with that of the above mentioned data distribution system.

As an optional aspect of the reception system, the reception portion may store the received symbol in an external storage device; and the decoding portion may include (i) a sub-symbol extraction portion for extracting the single sub-symbol from each of the received symbols, and storing the extracted sub-symbol in a primary storage device on condition that the number of received symbols reaches the predetermined number necessary for allowing the restoration of the sub-blocks prior to encoding, (ii) a decoding processing portion for decoding, according to the predetermined encoding/decoding formula, each of the sub-blocks posterior to encoding configured by the sub-symbols stored in the primary storage device by the sub-symbol extraction portion, and (iii) a sub-block storage portion for storing in the external storage each of sub-blocks posterior to decoding, which is generated by the decoding processing portion.

According to such a reception apparatus, even if the capacity of the primary storage device is small, a large volume of data can be received and decoded using the external storage.

According to a third aspect of the present invention, a computer readable program storage medium is provided as comprising instructions being executed by a computer, the instructions including a computer-implemented method for use in a reception apparatus cooperative with a distribution apparatus. The distribution apparatus is configured for (i) dividing an original data into several sub-blocks, (ii) encoding each of the sub-blocks, according to a predetermined encoding/decoding formula allowing data prior to encoding to be restored by obtaining a predetermined quantity of data from data posterior to encoding, to thereby generate each of sub-blocks posterior to encoding, each sub-block posterior to encoding containing several sub-symbols, and (iii) distributing each symbol which is generated by extracting a single sub-symbol from each of the sub-blocks posterior to encoding. The method for the use in the reception apparatus comprises: receiving the symbol from the distribution apparatus; and decoding, on a predetermined condition that a number of received symbols reaches a predetermined number necessary for allowing a restoration of the sub-blocks prior to encoding, each of sub-blocks posterior to encoding, the sub-blocks posterior to encoding which are configured by extracting a single sub-symbol from each of the received symbols, according to the predetermined encoding/decoding formula.

Such a computer readable medium can enable the computer to function as the above mentioned reception apparatus.

According to a fourth aspect of the present invention, a method for distributing data is provided as comprising: (i) dividing an original data into several sub-blocks; (ii) encoding each of the sub-blocks, according to a predetermined encoding/decoding formula allowing data prior to encoding to be restored by obtaining a predetermined quantity of data from data posterior to encoding, to thereby generate each of sub-blocks posterior to encoding, each sub-block posterior to encoding containing several sub-symbols; (iii) distributing each symbol which is generated by extracting a single sub-symbol from each of the sub-blocks posterior to encoding; and (iv) decoding, on a predetermined condition that a number of received symbols reaches a predetermined number necessary for allowing a restoration of the sub-blocks prior to encoding, each of sub-blocks posterior to encoding; the sub-blocks posterior to encoding being configured by extracting a single sub-symbol from each of the received symbols, according to the predetermined encoding/decoding formula.

Such a data distribution method, can provide an advantage comparable with that of the data distribution system mentioned above.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram showing an outline configuration of a data distribution system according to an embodiment of the present invention;

FIG. 2 is a diagram explaining a flow from data encoding/distributing to data receiving/decoding;

FIG. 3 is a flowchart of a transmission process executed by a server of an information center;

FIG. 4 is a flowchart of a reception process executed by a CPU of a control section of a navigation apparatus; and

FIG. 5 is a flowchart of a restoration process executed by the CPU of the control section of the navigation apparatus.

### DETAILED DESCRIPTION OF THE PREFERRED EMBODIMENTS

An embodiment according to the present invention will be explained with reference to drawings.

1. Overall Configuration

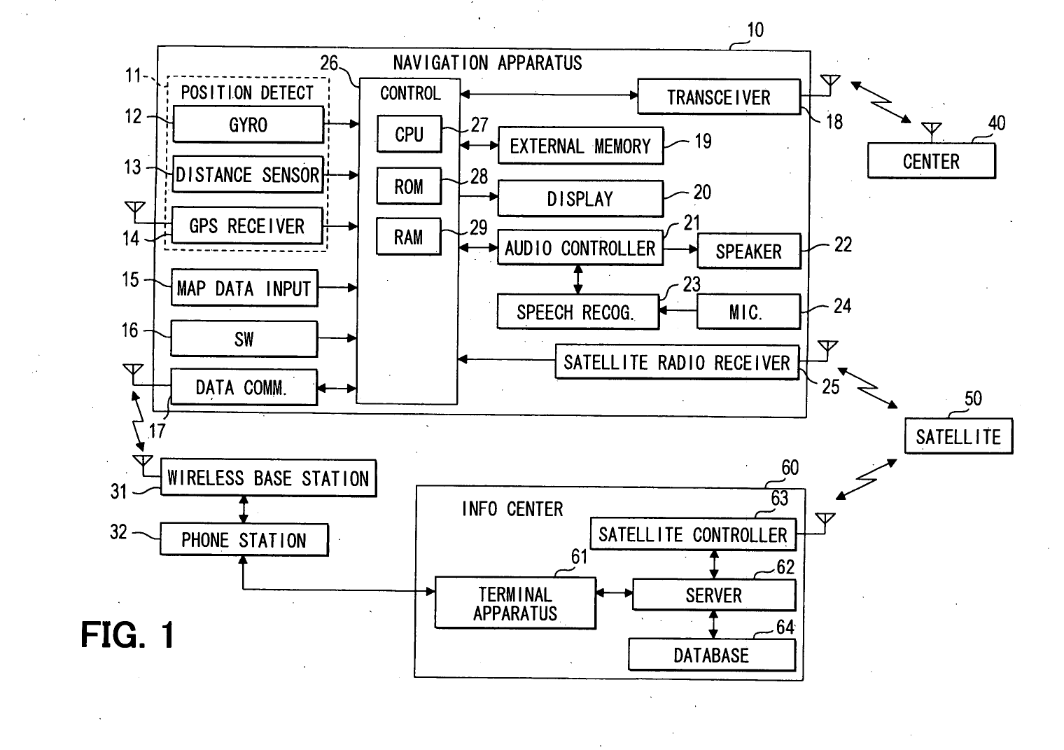

FIG. 1 is a block diagram showing an outline configuration of a data distribution system according to an embodiment of the present invention.

As illustrated in FIG. 1, the data distribution system includes a navigation apparatus 10 and an information center 60. The navigation apparatus 10 is mounted in a subject vehicle. The navigation apparatus 10 includes a position detection section 11, a map data input section 15, an operation switch group 16, a data communication section 17, a transceiver 18, an external memory 19, a display section 20, an audio controller 21, a speaker 22, a speech recognition section 23, a microphone 24, a satellite radio receiver 25, and a control section 26.

The control section 26 is configured as a usual computer to contain a known CPU 27, ROM 28, and RAM 29. The CPU 27 executes predetermined processes according to programs stored in the ROM 28 based on a variety of information inputted from the position detection section 11, the map data input section 15, the operation switch group 16, the data communication section 17, the transceiver 18, the external memory 19, and the audio controller 21.

The position detection section 11 is used for detecting a present position of the subject vehicle (referred to only as “vehicle”) in which the navigation apparatus 10 is mounted. The position detection section 11 includes a well-known gyroscope 12, distance sensor 13, and GPS (Global Positioning System) receiver 14. The individual sensors have different types of detection errors from each other; therefore, they are used to complement each other. In addition, part of the sensors or the like may be only used depending on the required detection accuracy or each sensor's detection accuracy. Further, another sensor or the like such as a steering angle sensor and a wheel speed sensor of a following wheel may be used.

The map data input section 15 is used for inputting the various data containing map data, data for map matching for improving positioning accuracy, and landmark data from a storage medium (not shown) inserted into the map data input section 15 itself. The storage medium storing the map data typically includes a CD-ROM or DVD-ROM from the viewpoint of the required data volume; further, a memory card or hard disk drive (HDD) can be alternatively used.

The operation switch group 16 is used for inputting the various instructions from a user. For example, as the operation switch group 16, a mechanical switch or touch-sensitive switch which is integrated with the display section 20 is used. According to a switch operation, operation instructions for various functions are issued to the control section 26.

The data communication section 17 has a reciprocal communication function. The data communication section 17 is configured of, for example, a portable terminal such as a cellular phone or an automobile phone, which is easily detachable from the control section 26. Alternatively, the data communication section 17 may be provided to be not easily detached and attached with the control section 26. The control section 26 acquires information on text, weather, other vehicles, facility, advertisement, etc. from the information center 60 by demanding the information via the data communication section 17.

The transceiver 18 receives traffic information etc. which is provided from an external center 40 (information infrastructures such as VICS (Vehicle Information and Communication System, registered trademark). The transceiver 18 transmits information on user, subject vehicle, etc. to the external center 40. The information received from the outside is processed by the control section 26. In addition, if required, the information processed by the control section 26 can be also outputted via the transceiver 18.

The external memory 19 is an external rewritable memory having a large data volume such as a hard disk drive (HDD). The external memory 19 stores data, which need to be inerasable even if power supply is turned off. The external memory 19 is also used for copying frequently used data via the map data input section 15.

The display section 20 displays maps or destination selection windows for navigating or guiding the vehicle in travel, and is able to display images in full colors using a liquid crystal display, an organic electroluminescence display, or a plasma display.

The audio controller 21 controls the speech recognition section 23 and carries out a talk-back output control via the speaker 22 to the user having inputted a speech. In addition, the audio controller 21 also inputs a recognition result of the speech recognition section 23 to the control section 26.

The speaker 22 announces a predetermined speech or voices such as voice guidance, explanation of display window operation, and speech recognition result based on audio output signals inputted from the audio controller 21. The speech recognition section 23 collates the user's input speech uttered via the microphone 24 with vocabulary data (patterns for comparison) in a recognition dictionary (not shown) stored inside, and then inputs the vocabulary having the greatest degrees of accord as the recognition result to the audio controller 21.

The microphone 24 inputs speeches uttered by the user as electric signals to the speech recognition section 23. The satellite radio receiver 25 is for receiving mobile object-oriented satellite digital sound broadcasts, for example, XM Satellite Radio, and receives data distributed via the satellite 50.

The control section 26 executes a predetermined process to the user's utterance based on the information inputted from the speech recognition section 23 via the audio controller 21. In addition, the route guidance voice information processed by the control section 26 is suitably announced from the speaker 22 via the audio controller 21.

The information center 60 includes a terminal apparatus 61, a server 62, and a database 64. The terminal apparatus 61 communicates with the navigation apparatus 10 via a telephone station 32. The server 62 processes necessary information such as information on text, weather, other vehicles, facility, advertisement, etc. The database 64 stores necessary information such as information on text, weather, other vehicles, facilities, advertisement, persons, etc. The information center 60 communicates with a wireless base station 31 via the telephone station 32. Thus, data can be transmitted and received via the wireless base station 31 between the information center 60 and the navigation apparatus 10.

In addition, the information center 60 has a function to process the information in the database 64 using the server 62 to be suitable for satellite broadcasting and distribute it as broadcast using a satellite controller 63. The data (contents data) is distributed to the navigation apparatus 10 via the satellite 50.

The information center 60 processes the present position information, which is acquired via the communication, using the server 62, and accumulates the processed information in the database 64. Upon receiving an information demand, the server 62 retrieves the required information from the database 64, and transmits the retrieved information using the terminal apparatus 61.

2. Outline of Data Distribution Method

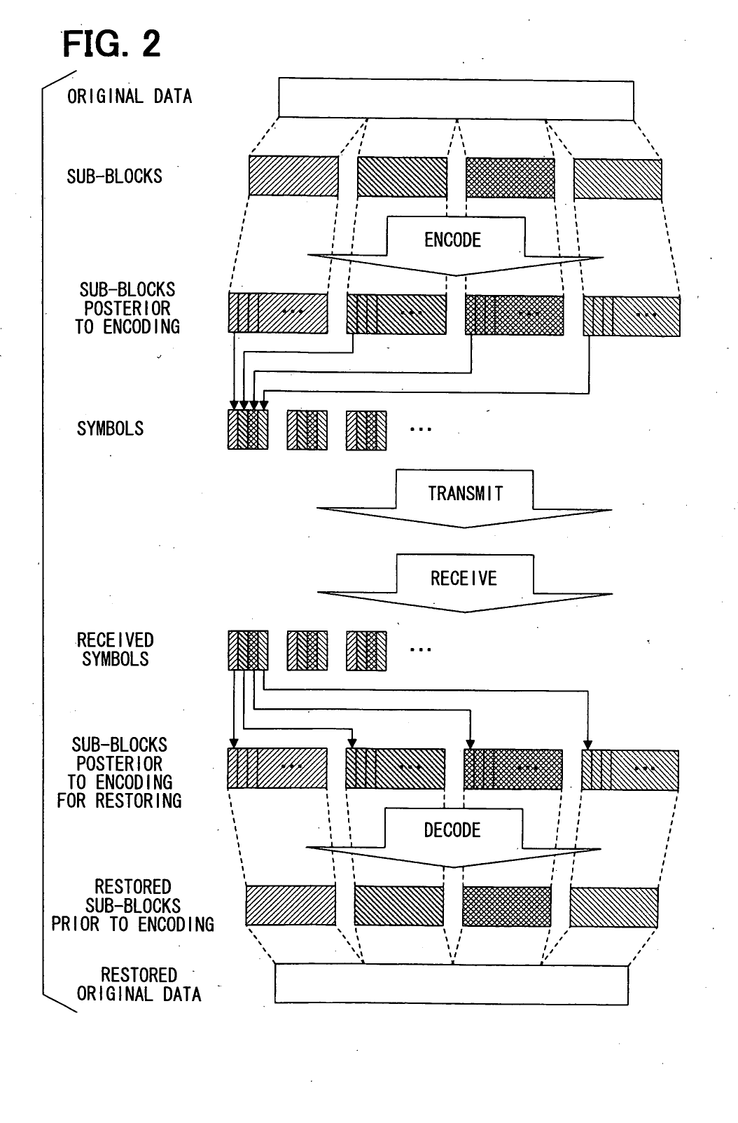

Next, the following explains, with reference to FIG. 2, a flow from the data encoding and distributing to the data receiving and decoding when the information center 60 distributes contents data to the navigation apparatus 10 via the satellite 50 in the data distribution system according to the present-embodiment.

The information center 60 functioning as a data distributing party or a distribution apparatus operates as follows. An original data is divided into N sub-blocks. Then, each of the N sub-blocks is encoded according to a predetermined encoding/decoding formula, to thereby generate several data, which are referred to as sub-symbols. In the predetermined encoding/decoding formula, data prior to encoding is restored by obtaining a predetermined quantity of data randomly from data posterior to encoding. Each symbol functioning as a single distribution data element or unit is then generated by extracting each single sub-symbol from each of the respective sub-blocks in order. That is, one symbol includes the N sub-symbols, wherein N corresponds to the number of the sub-blocks, in a predetermined order, which signifies that an order of a certain sub-symbol within each symbol is identical to an order of the original sub-block, from which the certain sub-symbol is extracted, within the several sub-blocks constituting the original data. The generated each symbol is distributed via the satellite 50.

In contrast, the navigation apparatus 10 functioning as a receiving party or a reception apparatus operates as follows. When completing the reception of the symbols of which the number is equal to or greater than a predetermined number (M) necessary for restoring the sub-blocks, sub-symbols are extracted sequentially from each of received several symbols (1st to M-th) so as to restore the sub-blocks posterior to encoding. Each of the restored sub-blocks posterior to encoding (1st to N-th), which can be also referred to as each of the restored sub-blocks prior to decoding, is decoded individually according to the predetermined encoding/decoding formula mentioned above to thereby restore each of the sub-blocks prior to encoding (1st to N-th), which can be also referred to as each of the sub-blocks posterior to decoding. The restored respective sub-blocks from 1st to N-th are then joined to one another in the ascending order (i.e., from 1st to N-th) to thereby restore the original data.

3. Explanation of Processes

Next, the respective processes executed in the navigation apparatus 10 and information center 60 are explained as follows.

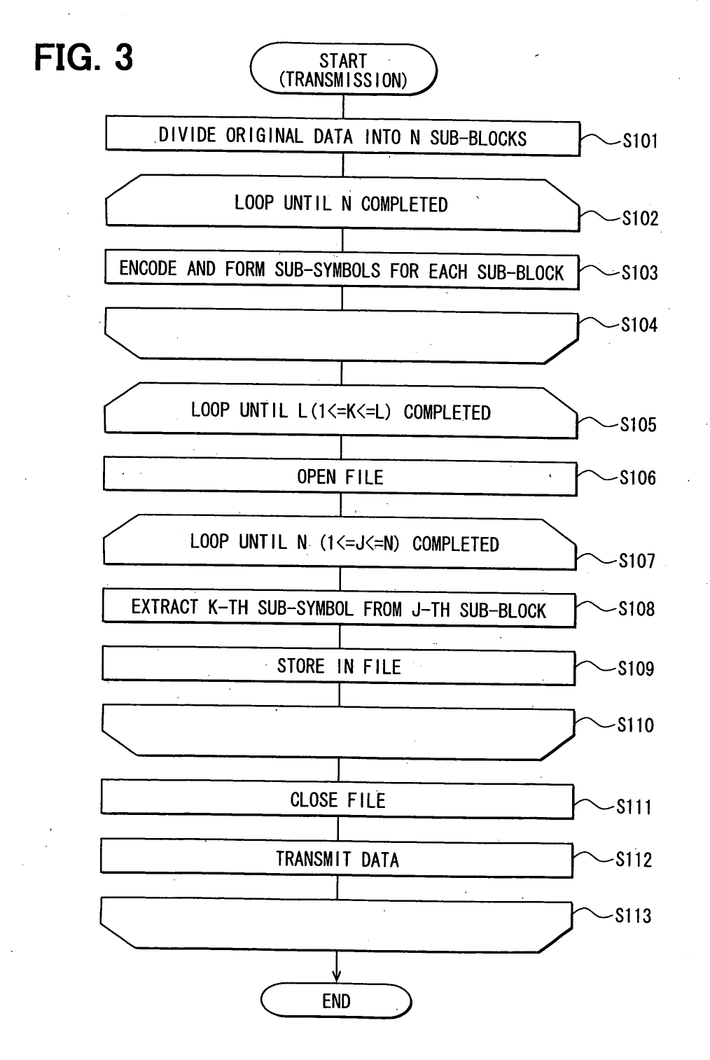

First, a transmission process is explained with reference to a flowchart of FIG. 3. The present process is executed by the server 62 of the information center 60 to distribute data, which is used in the navigation apparatus 10, via the satellite 50.

When the transmission process is started, at S101, the server 62 first divides the original data of distribution data into N sub-blocks. The division number of “N” is suitably determined according to the data size or data volume of the original data. More specifically, the division number of “N” is determined to enable each generated sub-block to be processed in the navigation apparatus 10 of a receiving party. For instance, it can be designed that the data size of each sub-block can be within a predetermined data size.

After the processing of S101, a loop processing of S102 to S104 is executed.

In the loop processing of S102 to S104, the processing of S103 is repeated N times corresponding to the number of sub-blocks. More specifically, at S103, according to a predetermined encoding/decoding formula, in which data prior to encoding is restored by obtaining a predetermined number of data from data posterior to encoding, the I-th sub-block (1<=I<=N) among the N sub-blocks is encoded to thereby generate several (infinite L pieces) sub-symbols every sub-block. Accordingly, after the loop processing of S102 to S104, each of the N sub-blocks is encoded to thereby generate a sub-block posterior to encoding including L sub-symbols.

After completing the loop processing of S102 to S104, a loop processing of S105 to S113 is executed. In the loop processing of S105 to S113, the processing of S106 to S112 is repeated L times corresponding to the number of the sub-symbols contained in each of the sub-blocks posterior to encoding.

In detail, at S106, a file for storing distribution data is opened. Then, the loop processing of S107 to S110 is executed. In the loop processing of S107 to S110, the processing of S108, S109 is repeated N times corresponding to the number of sub-blocks posterior to encoding. In detail, at S108, the K-th (1<=K<=L) sub-symbol is extracted from the J-th (1<=J<=N) sub-block posterior to encoding. Herein, K is the number of execution times up to N times with respect to the loop processing of S105 to S113; J is the number of execution times with respect to the loop processing of S108, S109. At S109, the extracted sub-symbols are stored in the file opened at S106. Accordingly, after completing the loop processing of S107 to S110, each K-th sub-symbol is extracted from the respective N sub-blocks posterior to encoding in the order from the 1st sub-block to the N-th sub-block and stored in the file. As a result, a single distribution data element corresponding to one symbol, which includes the K-th sub-symbols of the respective N sub-blocks posterior to encoding, is stored in the file.

After completing the loop processing of S107 to S110, the processing advances to S11, at which the file opened at S106 is closed. Then, at S112, the data distribution process is executed which transmits the distribution data element (symbol), which is stored in the file, using the satellite controller 63.

Accordingly, after completing the loop processing of S105 to S113, the L distribution data elements (symbols) are distributed to the navigation apparatus 10 via the satellite 50. After completing the loop processing of S105 to S113, the present transmission process ends.

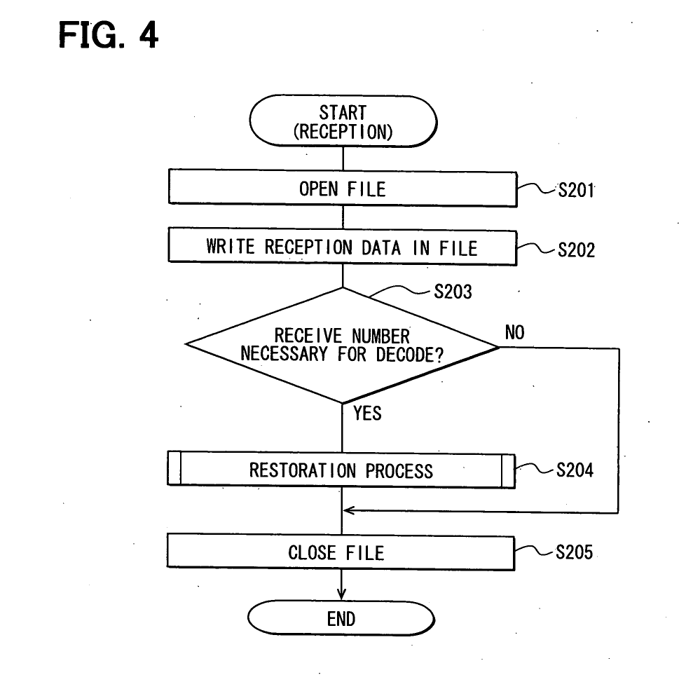

Next, the following explains, with reference to a flowchart of FIG. 4, a reception process, which is executed by the CPU 27 of the control section 26 in the navigation apparatus 10 for receiving the distribution data elements distributed from the information center 60 via the satellite 50. Furthermore, the present reception process is a process which receives a single distribution data element; thus, several distribution data elements can be received by repeatedly executing the present reception process.

After starting the reception process, at S201, the CPU 27 opens a file for writing received data. The present file for writing received data is prepared in the external memory 19. Then, at S202, the distribution data element (symbol) received by the satellite radio receiver 25 is written in the file for writing received data opened at S201. Furthermore, the distribution data is written in the file for writing received data in each of units of received symbols. In other words, each received symbol or distribution data element is written in the file for writing received data, respectively or independently. When any received distribution data element is already written in the file, the newly received distribution data element is written in the file so as to succeed the already stored distribution data element. That is, the received data elements are stored in the external memory 19 such that the manner (i.e., orders) of receiving the distribution data elements is indicated as it is.

Then, at S203, it is determined whether the number of the received distribution data elements reaches a predetermined number M, which is the minimum number necessary for decoding the sub-blocks posterior to encoding. When it is determined that the number of the received distribution data elements does not reach the predetermined number at S203, the processing advances to S205, at which the file for writing received data opened at S201 is closed. The present reception process is then ended.

In contrast, when it is determined that the number of the received distribution data elements reaches the predetermined number at S203, the processing advances to S204, at which a restoration process is executed to restore the original data using the distribution data elements (details are explained later). The processing thereafter advances to S205, at which the file for writing received data opened at S201 is closed. The present reception process is then ended.

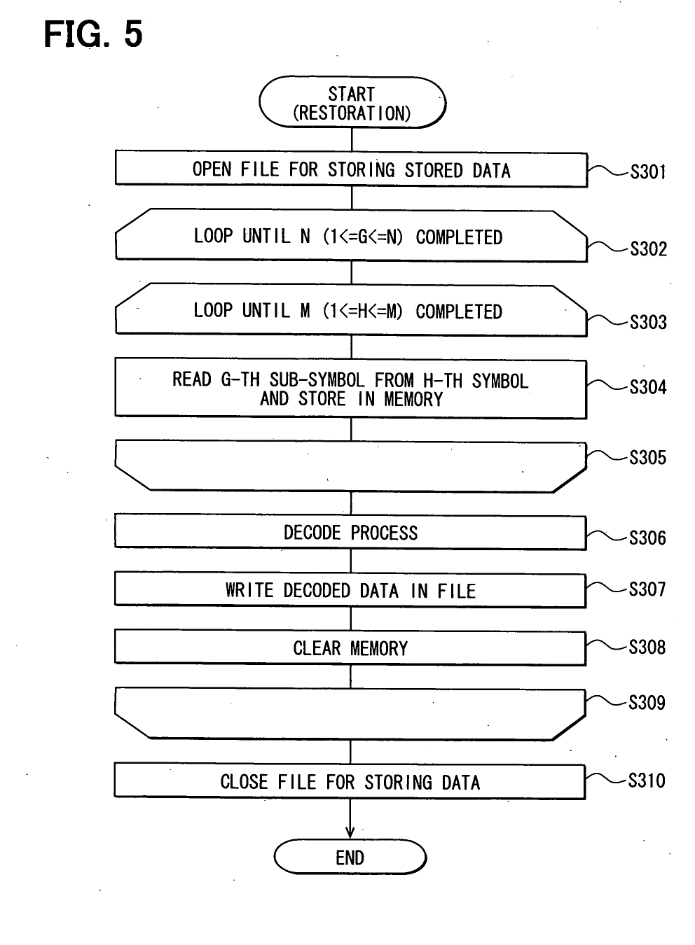

Next, the restoration process executed at S204 is explained with reference to the flowchart of FIG. 5. After starting the restoration process, at S301, the CPU 27 opens a file for storing restored data. The file for storing restored data is prepared in the external memory 19.

After the processing of S301, a loop processing of S302 to S309 is executed. In the loop processing of S302 to S309, the processing of S303 to S308 is repeated N times corresponding to the number of sub-blocks.

First, the loop processing of S303 to S305 is executed. In the loop processing of S303 to S305, the processing of S304 is repeated M times corresponding to the predetermined number necessary for decoding sub-blocks or the number of the received symbols. More specifically, at S304, the G-th sub-symbol is read out in order from the H-th symbol included in the received M symbols stored in the file for writing received data and stores the read-out sub-symbol in an area for storing sub-symbols in the RAM 29. Herein, H corresponds to the number of execution times up to M times of the present loop processing while G corresponds to the number of execution times up to N times of the loop processing of S302 to S309. Accordingly, by virtue of the loop processing of S303 to S305, it can be designed that the G-th sub-block posterior to encoding is restored in the RAM 29. Furthermore, although the read-out processing of the sub-symbols from the file for writing received data is executed M times, the symbols are written in the continuous region (the same file) of the external memory 19. Thus, it is considered that the cash of the CPU 27 is workable.

After the loop processing of S303 to S305 is completed, the processing advances to S306. At S306, the sub-block posterior to encoding, which is stored in the RAM 29, is decoded to thereby restore the corresponding sub-block prior to encoding.

Then, at S307, the sub-block posterior to decoding (restored sub-block) obtained by decoding at S306 is written in the file for storing restored data opened at S301. When any sub-block posterior to decoding is already written in the file for storing restored data, the newly sub-block posterior to decoding is written in the file so as to succeed the already stored sub-block.

Then, at S308, the area or memory for storing sub-symbols in the RAM 29 is cleared. Accordingly, the N sub-blocks are written in the file for writing restored data in order from the 1st to N-th by the loop processing of S302 to S309 (without rearrangement of the order). As a result, the original data (restored data) before being divided into the sub-blocks is thus stored in the file for storing restored data.

After completing the loop processing of S302 to S309, the processing advances to S310, at which the file for storing restored data opened at S301 is closed. The present process is then ended.

4. Effect

As explained above, in the data distribution system of the present embodiment, the information center 60 as the data distributing party, the original data is divided into several sub-blocks (S101), and processes encoding per sub-block (S102 to S104). Accordingly, in the navigation apparatus 10 as the data receiving party, even if the data size of the original data cannot be stored in the RAM 29 functioning as a primary storage device, the decoding process can be executed per sub-block. Therefore, according to the data distribution system of the present embodiment, the navigation apparatus 10 can receive a large volume of data, even if the capacity of the RAM 29 is small.

In addition, the navigation apparatus 10 operates as follows. On condition that the number of received symbols reaches a predetermined number, which allows a restoration of the sub-blocks (S203: YES), each sub-symbol is extracted sequentially from each of received several symbols. The sub-block posterior to encoding is stored in the RAM 29 and then decoded. The sub-block posterior to decoding is stored in the external memory 19 (S301 to S310). Accordingly, even if the capacity of the RAM 29 is small, a large volume of data can be received and decoded using the external memory 19.

In detail, with respect to the data size of the sub-block, it is desirable to be set as being as large as possible within the range which can be processed (received and decoded) in the RAM 29. If such a setting can be possible, the RAM 29 can be used effectively and the number of times of accesses to the external memory 19 can be lessened. In addition, in the present embodiment, data is distributed in units of symbols instead of units of sub-symbols. Thus, the number of times of accesses to the external memory 19 in the reception process of the distribution data can be lessened while transmission and reception of the data can be processed efficiently. As a result, the times of accesses to the external memory 19 by the CPU 27 can be reduced; Thus, the CPU may not be occupied by the accesses. The function to operate at real time of the CPU is not easily prevented.

In addition, it is designed that the information center 60 configures symbols in accordance with an order of the sub-blocks, which are formed by dividing the original data. Thus, in the navigation apparatus 10, the sub-blocks posterior to encoding and the original data can be easily restored only by extracting the sub-symbols from the received symbols in a predetermined order.

5. Functions

In the data distribution system of the present embodiment, the server 62 which executes the processing of S101 may function as a division means or portion; the server 62 which executes the processing of S102 to S104 may function as a encoding means or portion; and the server 62 which executes the processing of S105 to S113 may function as a distribution means or portion.

In addition, the CPU 27 which executes the processing of S201, S202, and S205 may function as a reception means or portion; the CPU 27 which executes the processing of S203, S204 (S301 to S310) may function as a decoding means or portion.

In particular, the server 62 which executes the processing of S303 to S305 may function as a sub-symbol extraction means or portion; the server 62 which executes the processing of S306 may function as a decoding means or portion; and the server 62 which executes the processing of S307 may function as a sub-block storage means or portion.

6. Modifications

Although the embodiment is described above, the present invention is not limited to the embodiment and can be modified in various manners.

For instance, in the present embodiment, the restoration process (FIG. 5) is executed when it is determined that the predetermined necessary number of distribution data elements can be received. Without need to be limited to the above, another may be adopted. The start of the restoration process may be delayed based on the operating state of the navigation apparatus 10, etc. For instance, a waiting process may be used to prevent the accesses to the external memory 19 from concentrating. In addition, when the process load of the restoration process affects the function of the high priority, or when the distribution data is not urgent information, the restoration process may not be executed at the time of the normal operation of the navigation apparatus 10, but be executed at the time of powering from the battery (i.e., when an Accessory switch is in an OFF state).

In addition, the navigation apparatus 10 is illustrated in the above embodiment as a reception apparatus or a receiving party which receives distribution data. Without need to be limited to the above, another may be adopted. The present invention can be also applied to any apparatus other than a navigation apparatus.

Each or any combination of processes, steps, or means explained in the above can be achieved as a software portion or unit (e.g., subroutine) and/or a hardware portion or unit (e.g., circuit or integrated circuit), including or not including a function of a related device; furthermore, the hardware portion or unit can be constructed inside of a microcomputer.

Furthermore, the software portion or unit or any combinations of multiple software portions or units can be included in a software program, which can be contained in a computer-readable storage media or can be downloaded and installed in a computer via a communications network.

It will be obvious to those skilled in the art that various changes may be made in the above-described embodiments of the present invention. However, the scope of the present invention should be determined by the following claims.

What is claimed is:

1. A data distribution system comprising:
a division means for dividing an original data into several sub-blocks;
an encoding means for encoding each of the sub-blocks,
according to a predetermined encoding/decoding formula allowing data prior to encoding to be restored by obtaining a predetermined quantity of data from data posterior to encoding,
to thereby generate each of sub-blocks posterior to encoding, each sub-block posterior to encoding containing several sub-symbols;
a distribution means for distributing each symbol which is generated by extracting a single sub-symbol from each of the sub-blocks posterior to encoding, the sub-blocks posterior to encoding which are generated by the encoding means; and
a decoding means for,
on a predetermined condition that a number of received symbols reaches a predetermined number necessary for allowing a restoration of the sub-blocks prior to encoding,
decoding each of sub-blocks posterior to encoding, the sub-blocks posterior to encoding which are configured by extracting a single sub-symbol from each of the received symbols, according to the predetermined encoding/decoding formula.

2. The distribution system according to claim 1, wherein
the distribution means configures each symbol such that an order of the sub-blocks, from which the sub-symbols are extracted, is constant.

3. A reception apparatus cooperative with a distribution apparatus,
the distribution apparatus
(i) dividing an original data into several sub-blocks,
(ii) encoding each of the sub-blocks, according to a predetermined encoding/decoding formula allowing data prior to encoding to be restored by obtaining a predetermined quantity of data from data posterior to encoding, to thereby generate each of sub-blocks posterior to encoding, each sub-block posterior to encoding containing several sub-symbols, and
(iii) distributing each symbol which is generated by extracting a single sub-symbol from each of the sub-blocks posterior to encoding,
the reception apparatus comprising:
a reception means for receiving the symbol; and
a decoding means for,
on a predetermined condition that a number of received symbols reaches a predetermined number necessary for allowing a restoration of the sub-blocks prior to encoding,
decoding each of sub-blocks posterior to encoding, the sub-blocks posterior to encoding which are configured by extracting a single sub-symbol from each of the received symbols, according to the predetermined encoding/decoding formula.

4. The reception system according to claim 3, wherein:
the reception means stores the received symbol in an external storage device; and
the decoding means including
a sub-symbol extraction means for extracting the single sub-symbol from each of the received symbols, and storing the extracted sub-symbol in a primary storage device on condition that the number of received symbols reaches the predetermined number necessary for allowing the restoration of the sub-blocks prior to encoding,
a decoding processing means for decoding, according to the predetermined encoding/decoding formula, each of the sub-blocks posterior to encoding configured by the sub-symbols stored in the primary storage device by the sub-symbol extraction means, and
a sub-block storage means for storing in the external storage each of sub-blocks posterior to decoding, which is generated by the decoding processing means.

5. A computer readable program storage medium comprising instructions being executed by a computer, the instructions including a computer-implemented method for use in a reception apparatus cooperative with a distribution apparatus,
the distribution apparatus
(i) dividing an original data into several sub-blocks,
(ii) encoding each of the sub-blocks,
according to a predetermined encoding/decoding formula allowing data prior to encoding to be restored by obtaining a predetermined quantity of data from data posterior to encoding,
to thereby generate each of sub-blocks posterior to encoding, each sub-block posterior to encoding containing several sub-symbols, and
(iii) distributing each symbol which is generated by extracting a single sub-symbol from each of the sub-blocks posterior to encoding,
the method for the use in the reception apparatus comprising:
receiving the symbol from the distribution apparatus; and
decoding,
on a predetermined condition that a number of received symbols reaches a predetermined number necessary for allowing a restoration of the sub-blocks prior to encoding,
each of sub-blocks posterior to encoding, the sub-blocks posterior to encoding which are configured by extracting a single sub-symbol from each of the received symbols, according to the predetermined encoding/decoding formula.

6. A method for distributing data,
the method comprising:
dividing an original data into several sub-blocks;
encoding each of the sub-blocks, according to a predetermined encoding/decoding formula allowing data prior to encoding to be restored by obtaining a predetermined quantity of data from data posterior to encoding, to thereby generate each of sub-blocks posterior to encoding, each sub-block posterior to encoding containing several sub-symbols;
distributing each symbol which is generated by extracting a single sub-symbol from each of the sub-blocks posterior to encoding; and
decoding,
on a predetermined condition that a number of received symbols reaches a predetermined number necessary for allowing a restoration of the sub-blocks prior to encoding,
each of sub-blocks posterior to encoding, the sub-blocks posterior to encoding being configured by extracting a single sub-symbol from each of the received symbols, according to the predetermined encoding/decoding formula.
